(19) United States
(12) Patent Application Publication
(10) Pub. No.: US 2003/0035446 A1
(43) Pub. Date: Feb. 20, 2003

(54) Frequency selective tunable mirror and applications thereof

(76) Inventor: Giora Griffel, Tenafly, NJ (US)

Correspondence Address: DUANE MORRIS LLP, 100 COLLEGE ROAD WEST, SUITE 100, PRINCETON, NJ, 08540-6604, US

(21) Appl. No.: 10/194,620

(22) Filed: Jul. 12, 2002

Related U.S. Application Data
(60) Provisional application No. 60/305,245, filed on Jul. 13, 2001.
(60) Provisional application No. 60/305,244, filed on Jul. 13, 2001.

(51) Int. Cl. H01S 3/10; H01S 3/08

(52) U.S. Cl. 372/20; 372/99

(57) ABSTRACT

A wavelength-dependent variable mirror suitable for application in tunable semiconductor lasers is disclosed. The variable mirror comprises a coupler having two input ports and two output ports operable to distribute a known level of light coupled into a first input port, optical channels extending from each of the two coupler output ports of and a wavelength-selective device connected to each of the extended optical channels. In one aspect, the wavelength selective device connects the two extended channels forming an optical loop, which reflects a known level of light back to the coupler input ports. In another aspect, the wavelength selective device reflects a known level of light at a predetermined wavelength back to each of the extended channels to an input port of said coupler. In yet another aspect, a phase controlling element is introduced in at least one optical channel, which introduces a known amount of phase change in the light sent back to the coupler. In one application, a tunable laser is fabricated using a gain medium in conjunction with wavelength-selective variable mirror that operates to reflect a known level of light energy into a gain material to achieve lasing operation at a designated frequency.

### CLAIM OF PRIORITY

This application claims the benefit pursuant to 35 USC §119, of the earlier filing date of U.S. Provisional Applications;

Serial No. 60/305,245, entitled, “Tunable Laser Using Half Mach-Zehnder Device with Reflection Grating, having a filed date of Jul. 13, 2001; and

Serial No. 60/305,244, entitled “Frequency Dependent Variable Mirror And Applications,” having a filing date of Jul. 13, 2001, which are incorporated by reference herein.

### FIELD OF THE INVENTION

The present invention is directed to frequency-selective mirrors and more particularly to their application in frequency-selective semiconductor tunable lasers.

### BACKGROUND OF THE INVENTION

FIG. 1 illustrates a cross sectional view of a conventional semiconductor laser 100. Laser 100 is composed of an active region 110 composed of a light generating and amplifying layered material that generates photons, such as InGaAsP/InP, and providing optical gain to existing photons flowing through the active region, when activated by electrical current driven across the layered structure. Regions 120 and 125 opposing active region 110 create a waveguide that maintains the generated photons guided within active region 110. Partially reflective materials 130 and 135 at the ends of active region 110 provide reflective surfaces that reflect generated photons and form a cavity. Light propagating back and forth between the reflective cavity ends builds up through a constructive interference process. When sufficient gain within the cavity is provided to overcome propagation and reflection losses, lasing action takes place, resulting in a concentrated beam of light emerging from the ends of the semiconductor structure. In a common configuration one reflecting end surface is partially reflective and one is fully reflective. In this manner the laser light emerges from the semiconductor structure in a known direction. As is known in the art, the reflective surfaces may be facet edges of the semiconductor gain material structure.

As known in the art, the frequency, wavelength or color, the terms which are interchangeably used herein to describe the spectral characteristics of the lasing light, depends on the material used in the active region and the length of the cavity created between the reflective surfaces, as the constructive interference pattern is frequency dependent. Accordingly, the available frequency, wavelength or color output of each semiconductor laser is limited and predetermined by the choice of material system, the layered structure and the dimensions of the cavity comprising the laser. Conventionally, the structure described above, namely that of gain material placed between two reflecting mirrors, which is referred to as a Fabry-Perot (FP) laser. The FP laser is characterized by having a plurality of equally-spaced operating wavelengths, where the number of lasing wavelengths, their exact position within the gain spectrum and their relative intensity is somewhat random and determined by a variety of operating conditions such as the drive current, the operating temperature, the material system and dimensions of the laser structure. This non-deterministic operation is detrimental for many applications where the precise wavelength of the light emitted by the laser and its stability is of critical importance.

To overcome these limitations of the FP laser, a periodical layer is introduced into the layer structure. This periodic layer functions as a distributed reflective mirror, replacing the end mirrors. This type of periodical reflective mirror is frequency dependent, resulting in single wavelength lasing action. Lasers built in this manner are referred to as distributed feedback lasers or DFB lasers. Nevertheless, once a DFB laser is fabricated, the operating wavelength is fixed and predetermined, except for slow and limited variation that can be obtained by changing the operating temperature.

In WDM (Wavelength Division Multiplex) telecommunication systems, a plurality of lasers of different wavelengths provide the signal carriers for signal transmission. In such systems, the operating wavelength of each laser element is individually specified, fabricated and adjusted for proper system operation. Thus, in a 16-channel WDM system, 16 lasers, each operating on a separate frequency, wavelength or color must be obtained and incorporated into the system. This process is expensive as individual lasers must be fabricated, tested, inventoried, and correctly incorporated into a typical WDM system. As the number of wavelengths in a WDM system increases, e.g., 128, 256, etc., a significant cost and burden is imposed on the laser manufacturers and system developers to manage the increased number of different lasers needed.

Tunable lasers, as known in the art, represent one means for reducing the number of different and unique lasers needed in WDM systems. One example of a tunable laser is an intra-cavity multiple-section laser that allows for separate gain and wavelength control. A second example of a tunable laser is the external cavity laser (ECL) that uses an external, frequency selective, reflection surface, such as a reflection grating, outside the gain medium or active region. However, the former is difficult to manufacture and thus has problems with yield. Furthermore, there are problems with current and voltage control. The latter type is bulky and critically dependent on alignment and mechanical stability. In addition, as the ECL uses a frequency selective element as one of the cavity mirrors, it is limited to reflection grating type filters as the wavelength control element. This type of reflection grating has limited efficiency and does not provide a means to control the magnitude of reflection at a given frequency.

Thus, there is a need for wavelength selective mirrors that may be used to fabricate semiconductor lasers that are selectively operable at one of a plurality of frequencies or wavelengths, which are further tunable, variable in reflectivity, mechanically stable, and may be constructed using both reflective and transmissive adjustable filter configurations.

### BRIEF DESCRIPTION OF THE DRAWINGS

FIG. 1 illustrates a conventional prior art semiconductor laser;

FIG. 2 illustrates a block diagram of a tunable laser in accordance with the principles of the present invention;

FIG. 3a illustrates one aspect of the present invention using a Mach-Zehnder interferometer;

FIG. 3b illustrates a second aspect of the present invention using a Mach-Zehnder interferometer;

FIGS. 4a-4c illustrate different optical couplers operable in accordance with the principles of the invention;

FIG. 5 illustrates a second aspect of the present invention using a reflective filter in a Michelson interferometer configuration;

FIG. 6a illustrates a third aspect of the present invention using a non-reflective filter;

FIG. 6b illustrates another aspect of the present invention using a non-reflective filter;

FIG. 7 illustrates a graph of the experimental wavelength output of a tunable laser illustrated in FIG. 6b as a function of displacement that adjusts the a filter tilt angle; and

FIG. 8 illustrates a graph of experimental results output power spectra of a tunable laser as shown in FIG. 6b.

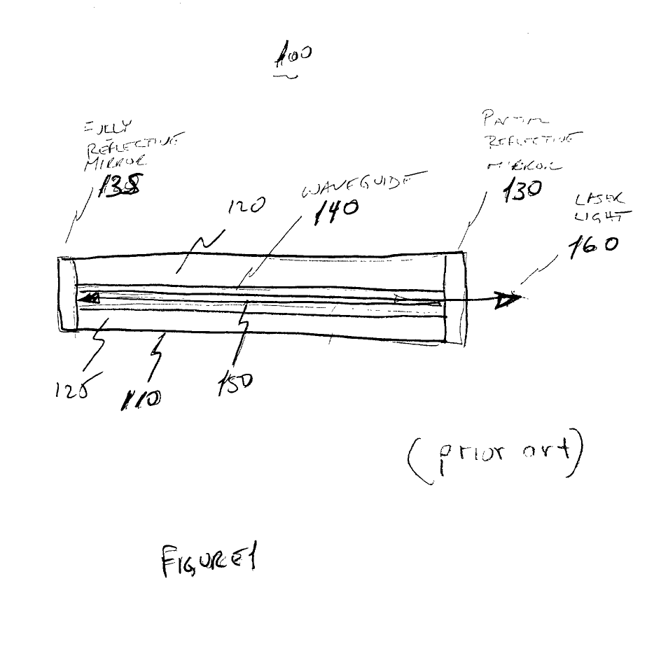

FIGS. 1 through 8 and the accompanying detailed description contained herein are to be used as an illustrative embodiment of the present invention and should not be construed as the only manner of practicing the invention. It is to be understood that these drawings are for purposes of illustrating the concepts of the invention and are not to scale. It will be appreciated that the same reference numerals, possibly supplemented with reference characters where appropriate, have been used throughout to identify corresponding parts.

### DETAILED DESCRIPTION OF THE INVENTION

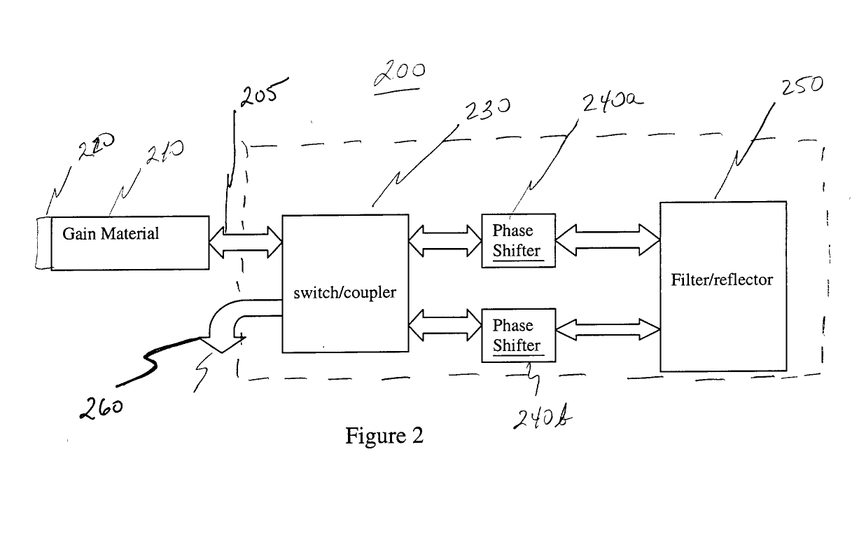

FIG. 2 illustrates a block diagram of a generalized tunable laser 200 in accordance with the principles of the invention. In this generalized configuration, gain material 210 includes highly-reflective (HR) surface 222 and a clear or an anti-reflective (AR) surface (not shown). Anti-reflective coating is preferred as it prevents reflection back into gain material 120. Also, the channel guiding the light in a semiconductor type gain medium can be formed at an angle with respect to the material facet to further reduce reflection from the surface.

Light 205 generated by gain material 210 is applied to a first input port of 2×2 coupler 230, wherein light 205 is split in known levels associated with each output port. The light exiting each of the outputs of coupler 230 is then applied to phase adjustment modules 240a, 240b, respectively, wherein a known level of phase is introduced. The phase adjusted light is next applied to wavelength-selective device 250, which is operable to return back at least one predetermined, selected or desired wavelength. Hence, the wavelength subsequently returned to gain medium 220 for continued amplification and a portion of the applied light energy emerges from the second coupler input port as laser light 260. As will be explained further, the selected wavelength may be returned to gain material 210 either by reflection or transmission.

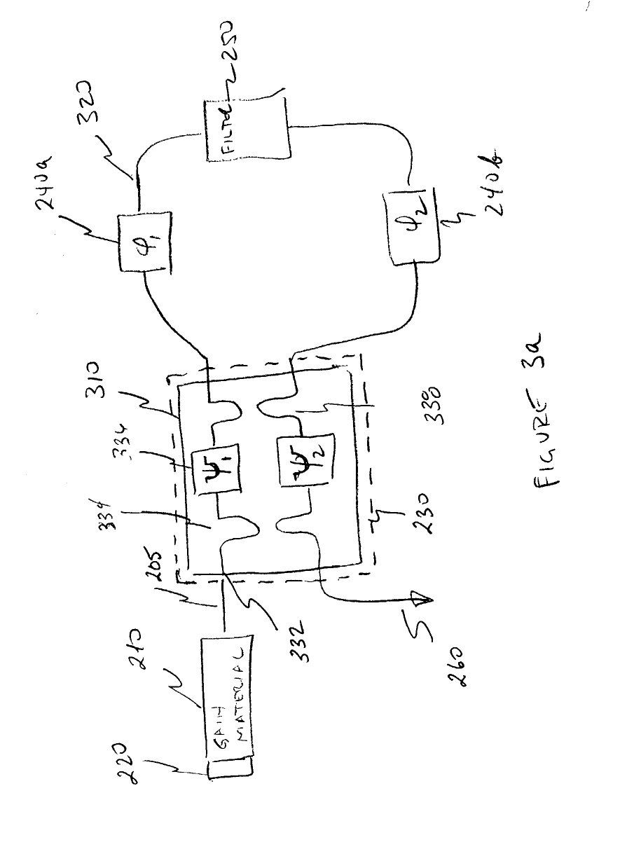

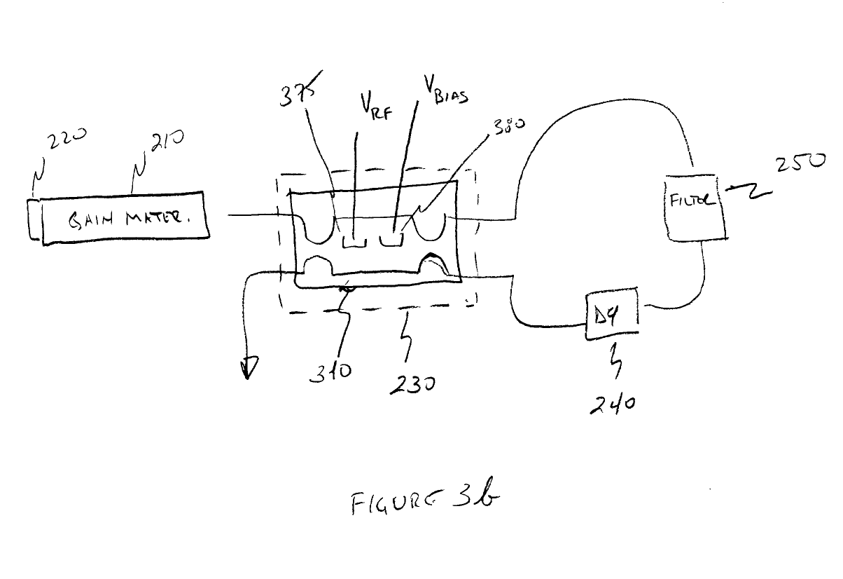

FIG. 3a illustrates one aspect of the present invention wherein a Mach-Zehnder interferometer 310 (MZI) is used as 2×2 cross-coupling switch 230. In this illustrated aspect, light energy 205 generated in gain material 210 is applied to port 332 of Mach-Zehnder interferometer 310. Light 205 is split in a first input coupling stage 334, phase shifted in phase shifter stage 336 and then split again in second output coupling stage 338. Mach-Zehnder interferometers are well known in the art and need not be discussed in detail.

Associated known levels of light exiting MZI 310 at correpsondign output ports are then applied to phase control elements 240a, 240b, through an optical path that can be made using an optical fiber or an embedded waveguiding channel. Phase control elements 240a, 240b apply phase values φ₁, φ₂, respectively to the phase value of the light portions passing therethrough. Phase values φ₁, φ₂, as will be appreciated, can be identical in magnitude and opposite in sign, i.e., φ₁=−φ₂=φ or can have other values, such as φ₁=0 and φ₂=φ. In addition, phase control elements 240a, 240b may be incorporated into or may be monolithically integrated with the Mach-Zehnder interferometer 310. The incorporation of the phase control elements 240 is advantageous as it does not increase the cost of the interferometer 310 as the electrodes for the phase control elements 240a, 240b may be fabricated at the same time the phase electrodes of the MZI 310 are fabricated. It would also be appreciated that the comparable phase difference relation may be achieved using only one phase control unit, either 240a or 240b, represented as 240.

The phase adjusted outputs are applied to opposite ends of a filter unit 250, which in this illustrated aspect is a frequency/time dependent filter possessing a characteristic represented as T(ω,t). Filter 250, for example, may be a partial reflective/partial transmission filter, such as tunable Fabry-Perot filter that transmits a narrow linewidth about a single frequency within a given frequency range, known as the Free Spectral Range (FSR), and reflects all other frequencies. Similarly, filter 250, may be a fully reflective filter, such as a Fiber Bragg Grating (FBG) or a fully transmissive filter, such as multi-layered dielectric tilt filter.

The equations governing the relationship between the input electric field Eᵢ and the reflected electric field Eᵣ and the transmitted electric field Et, of the illustrated variable mirror of FIG. 3a, can be shown to be:

$$\begin{matrix}\frac{{E}_{r}}{{E}_{i}} = {ⅇ}^{jϕ} [ {t}_{f} sin ( 2 ψ ) {ⅇ}^{j Δ ϕ} - {r}_{f} ( {sin}^{2} ψ + {ⅇ}^{j2 Δϕ} {cos}^{2} ψ ) ] , and & ( 1 ) \\ \frac{{E}_{t}}{{E}_{i}} = - {ⅇ}^{jϕ} [ - {r}_{f} sin ψ cos ψ ( 1 - {ⅇ}^{j 2 Δ ϕ} ) + {t}_{f} ( {cos}^{2} ψ - {sin }^{2} ψ ) {ⅇ}^{j Δϕ} ] , & ( 2 )\end{matrix}$$

where Δφ=φ₂−φ₁;

φ=φ₁+φ₂;

t_{f} and r_{f} are the field transmission and reflection of the filter unit, respectively; and

ψ is the phase angle of the MZI.

In one aspect, when φ₁=φ₂=0 and Δφ=0, then equations 1 and 2 are represented as:

$$\begin{matrix}\frac{{E}_{r}}{{E}_{i}} = {t}_{f} sin ( 2 ψ ) - {r}_{f} , and & ( 3 ) \\ \frac{{E}_{t}}{{E}_{i}} = {t}_{f} cos ( 2 ψ ) . & ( 4 )\end{matrix}$$

In this case, the reflected field is comprised of a portion of the field transmitted by the filter unit, i.e., t_{f} sin(2ψ), and the full value of the field reflected by the filter unit, i.e., r_{f}. It will also be understood that in many circumstances mixing the transmission with the reflection, as given by equation 3, is undesirable as it prevents frequency discrimination of the reflection field based on only a single frequency characteristic provided by either the reflection or the transmission of the filter unit.

Incorporation of at least one phase control unit 240a, 240b to introduce phase angle values φ₁ and φ₂ respectively, into the path length allows for the adjustment of the phase value in the fiber loop to be tuned to a known value. In one aspect, the fiber loop phase value may be tuned such that a substantially 90 degree phase shift, i.e.,

$$Δ ϕ = \frac{π}{2} ,$$

exists between the upper and lower halves of the fiber loop. In this case, the field reflection and field transmission ratios, from equations 1 and 2, are represented as:

$$\begin{matrix}\frac{{E}_{r}}{{E}_{i}} = {ⅇ}^{jϕ} [ {jt}_{f} sin ( 2 ψ ) + {r}_{f} cos ( 2 ψ ) ] , and & ( 5 ) \\ \frac{{E}_{t}}{{E}_{i}} = - {ⅇ}^{jϕ} [ - {r}_{f} sin ( 2 ψ ) + {jt}_{f} cos ( 2 ψ ) ] & ( 6 )\end{matrix}$$

In this case, the reflection and transmission of the variable mirror may be substantially controlled with an appropriately selected phase value of the MZI 310. For example, when the phase of MZI 310 is 45 degrees, i.e.,

$$ψ = \frac{π}{4}$$

then equations 5 and 6 are represented as::

$$\frac{{E}_{r}}{{E}_{i}} = {jt}_{f} {ⅇ}^{jϕ} -> and \frac{{E}_{t}}{{E}_{i}} = {jr}_{f} {ⅇ}^{j ϕ} -> \qquad ( 7 )$$

The intensities of the transmitted and reflected signals may then be determined as:

$${\vert \frac{{E}_{r}}{{E}_{i}} \vert}^{2} = {\vert {t}_{f} \vert}^{2} and {\vert \frac{{E}_{t}}{{E}_{i}} \vert}^{2} = {\vert {r}_{f} \vert}^{2} \qquad ( 8 )$$

Hence, the overall reflection of the electrical field is a function of only the filter transmission value and the overall transmission of the electrical field is a function of only the filter reflection value.

On the other hand, if the phase value of MZI 310 is set to 90 degrees, i.e.,

$$ψ = \frac{π}{2} ,$$

then equations 5 and 6 are represented as::

$$\frac{{E}_{r}}{{E}_{i}} = - {r}_{f} {ⅇ}^{jϕ} and \frac{{E}_{t}}{{E}_{i}} = {jt}_{f} {ⅇ}^{j ϕ} \qquad ( 9 )$$

The corresponding intensities then may be determined as:

$${\vert \frac{{E}_{r}}{{E}_{i}} \vert}^{2} = {\vert {r}_{f} \vert}^{2} and {\vert \frac{{E}_{t}}{{E}_{i}} \vert}^{2} = {\vert {t}_{f} \vert}^{2} \qquad ( 10 )$$

In this case, the overall reflection of the electrical field is a function of only the filter reflection value and the overall transmission of the electrical field is a function of only the filter transmission value.

Accordingly, in this aspect of the invention, the phase, ψ, of MZI 310, may be used to determine any combination of the filter reflection (r_{f}) and/or transmission (t_{f}) that is reflected back into gain material 210. Hence, the fiber loop responds as a partially transmissive/partially reflective external second mirror to the gain material that allows a known amount of reflective energy to be returned to gain material 210 at a given frequency determined as by the filter characteristics.

As the transmission or reflection characteristics of filter 250 may be selectively chosen to specific spectral characteristics, a laser fabricated in accordance with the external fiber loop mirror shown in FIG. 3a may be operated in a single frequency mode. In this case, filter 250 may be tuned to a designated lasing frequency or wavelength, while control of the phase values ψ of the MZI and Δφ in the fiber loop allows known level of reflection energy to be returned to the gain medium 210 to achieve lasing operation at maximum output power.

MZI 310 is a preferred device for a 2×2 coupler 230, as its phase, ψ, may be electrically controlled and adjusted as shown in FIG. 3b. In this case, the MZI 310 may have two electrodes that provide control to the resultant phase value, ψ. One control 380 may be used to provide a substantially constant or slowly varying phase change for biasing the MZI 310 to a known value, while the second electrode 375 may be used to apply a fast varying radio frequency (RF) signal. In this case, a modulation signal may be applied to the RF electrode 375 and may be used to either apply information on the laser light or enable the laser to operate in a mode-locked fashion, generating high-repetition-rate pulse train.

Although MZI 310 is shown operable as coupler 230, it will be appreciated that other devices have been contemplated and considered to be applicable for use as coupler 230. For example, coupler 230 may be a fixed ratio directional coupler, a side-polished sliding variable optical fiber coupler, which provides an output split ratio as a function of a position between two fibers, a multi-mode interference (MMI) coupler, or an overcoupled directional coupler, which provides a variable output split ratio as a function of wavelength.

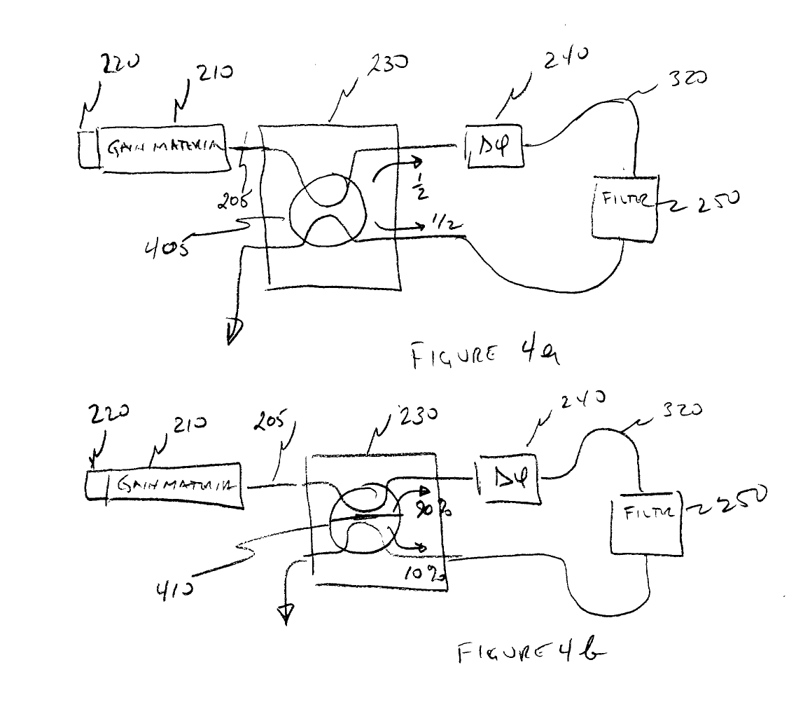

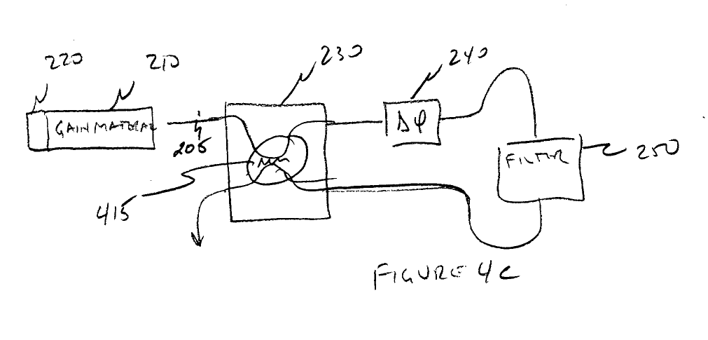

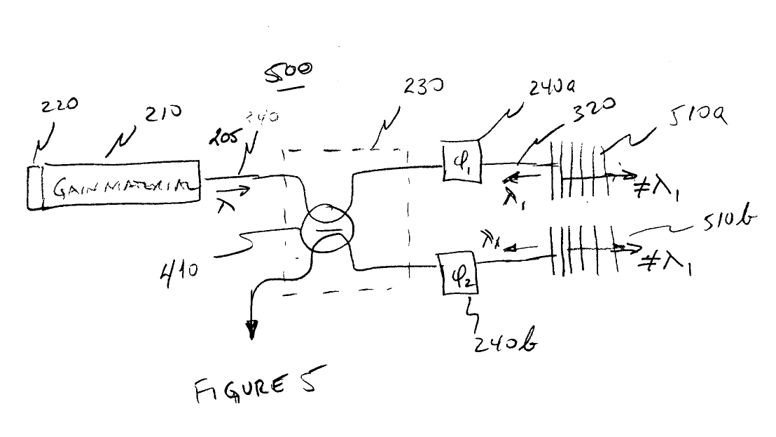

FIG. 4a illustrates a second embodiment of the present invention, wherein a 3 dB coupler 405 is utilized as 2×2 switch coupler 230. In this case, light 205 entering coupler 230 is equally split such that one-half the light energy is associated with each leg of fiber 320. In this illustrated embodiment a phase difference, Δφ, may be introduced in fiber 320 by phase device 240. In this case, filter 250 in one aspect may be a reflection type filter as described herein.

FIG. 4b illustrates a third embodiment of the present invention, wherein a variable optical splitter 410 is utilized as coupler 230. In this embodiment, splitter 410 may split input light 205 such that known percentages of light energy are associated with each leg of fiber 320. In this illustrated example, splitter 410 splits input light 205 such that 90% of the light energy is directed in one leg of fiber 320 and the remaining 10% of the input light energy is directed in the second leg of fiber 320. As would be appreciated variable splitter 410 may also be an optical tap with fixed level of optical diversion.

FIG. 4c illustrates a fourth embodiment of the present invention, wherein an optical over-coupled directional coupler (ODC) 415 is utilized as coupler 230. In this embodiment, ODC 415 determines the amount of energy transmitted in each fiber leg based on the length of the fiber coupling (L) and a coupling factor (κ). ODC 415 may also isolate a single frequency or wavelength from input light 340 such that a known percentage of the isolated wavelength of light energy is transmitted in each leg of fiber 320.

FIG. 5 illustrates an exemplary second aspect of the present invention 500, wherein a reflective filter is utilized as filter 250. In this case reflective filter may be Bragg Grating Filter (BGF) that reflects a single wavelength, represented as λ₁, while allowing other wavelengths, represented as ≠λ₁, to be transmitted outside fiber 320. In this illustrated case, each leg of fiber 320 includes a Bragg Grating Filter 510a, 510b having a reflectivity represented as r₁, r₂, respectively.

In this exemplary second aspect the field reflection and field transmission ratios may be determined as:

$$\begin{matrix}\frac{{E}_{r}}{{E}_{i}} = \frac{1}{2} {ⅇ}^{j2 \overline{φ}} ( {r}_{1} {ⅇ}^{- jΔφ} - {r}_{2} {ⅇ}^{jΔφ} ) ; and & ( 11 ) \\ \frac{{E}_{t}}{{E}_{i}} = \frac{1}{2} {ⅇ}^{j2 \overline{φ}} ( {r}_{1} {ⅇ}^{- jΔφ} + {r}_{2} {ⅇ}^{jΔφ} ) where \\ \begin{matrix}\overline{φ} = \frac{{φ}_{1} + {φ}_{2}}{2} \\ Δφ = {φ}_{2} - {φ}_{1}\end{matrix} & ( 12 )\end{matrix}$$

Δ100 =φ₂−φ₁

Further, when the reflectivity of each filter 510, 510b is substantially equal, then r₁=r₂=r_{f} and the field reflection and field transmission ratios may be determined as:

$$\frac{{E}_{r}}{{E}_{i}} = {ⅇ}^{j2 \overline{φ}} {r}_{f} sin ( Δφ ) and \frac{{E}_{t}}{{E}_{i}} = {ⅇ}^{j2 \overline{φ}} {r}_{f} cos ( Δφ ) \qquad ( 13 )$$

The reflective and transmission signal intensities may then be determined as:

$${\vert \frac{{E}_{r}}{{E}_{i}} \vert}^{2} = {r}_{f}^{2} {sin}^{2} ( Δφ ) and {\vert \frac{{E}_{tr}}{{E}_{i}} \vert}^{2} = {r}_{f}^{2} {cos}^{2} ( Δφ ) \qquad ( 14 \}$$

If r_{f} describes the reflectivity at a known wavelength, λ₁, with negligible reflectivity at other wavelengths, then the illustrated variable mirror will reflect back to the gain material at λ₁ with a split ratio determined by the the phase change Δφ as described by equation 14.

However, when the spectral characteristics of filters 510a and 510b are different such that at λ₁ filter 510a exhibitsthe same reflectivity. i.e., r₁=r₂≡r_{f}, while at λ₂ filter 510a exhibits reflectivity r₁=r_{f} and filter 510b exhibits reflectiveity r₂=0, then the reflective and transmission signal intensities at X1 are determined using equation 14, and at λ₂ the reflective and transmission signal intensities may be determined from equations 11 and 12 as:

$${\vert \frac{{E}_{r}}{{E}_{i}} \vert}^{2} = \frac{{r}_{f}^{2}}{4} and {\vert \frac{{E}_{t}}{{E}_{i}} \vert}^{2} = \frac{{r}_{f}^{2}}{4} \qquad ( 15 )$$

Hence, the configuration illustrated in FIG. 5 may be used as a wavelength selectable tuning element with two different reflective grating filters providing:

$$sin Δφ \geq \frac{1}{2} \qquad ( 16 )$$

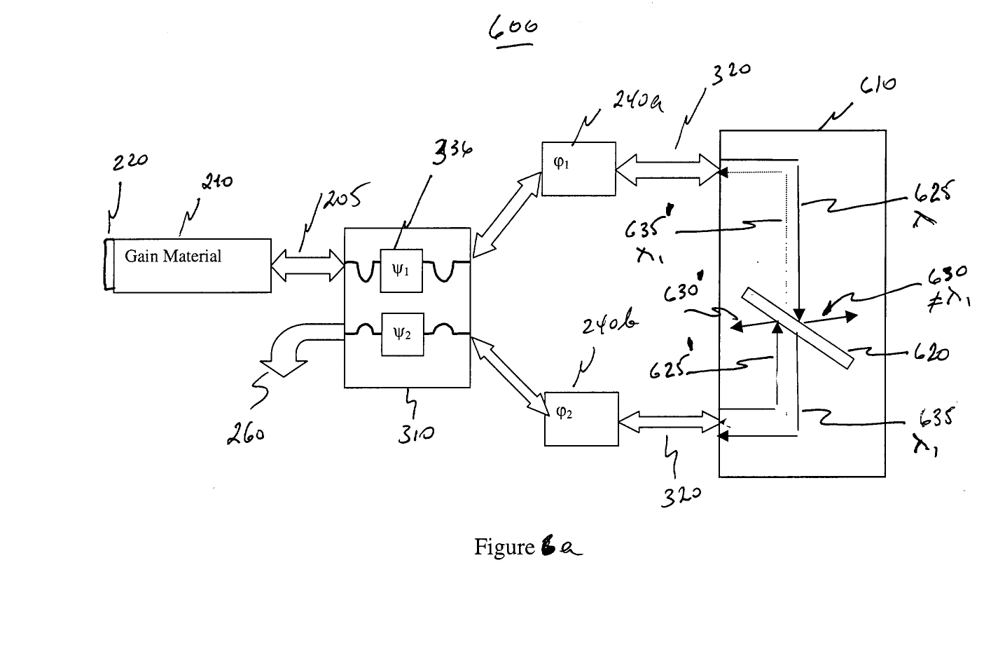

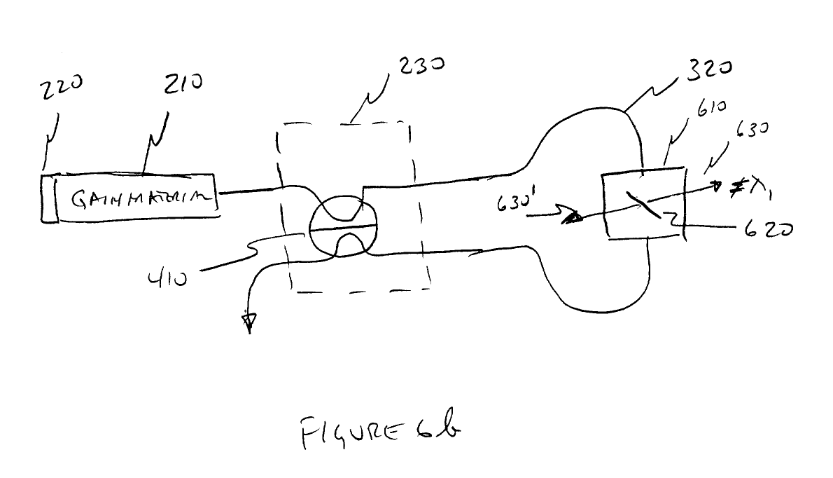

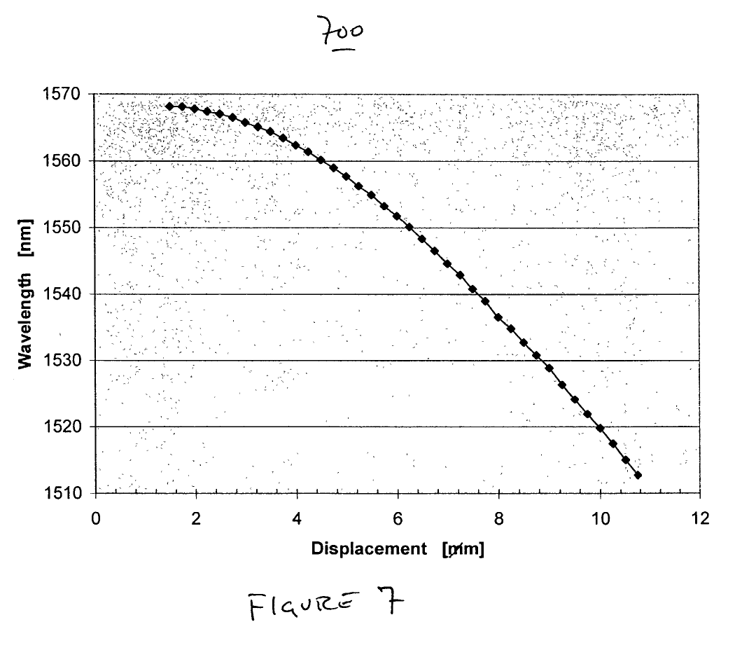

FIG. 6a illustrates still another aspect 600 of the present invention wherein a non-reflective filter 610 is utilized as filter 250. In this aspect, light energy 205 generated by gain material 210 is channeled to the two legs of fiber 320 by the illustrated MZI 310, as previously described. The phase of light in each leg of fiber 320 is then phase adjusted by phase controllers 240a, 240b, respectively. The phase adjusted light 625, 625′ is next applied to non-reflective filter 610. In this illustrative example, light 625, represented as λ, is that light energy traversing fiber 320 in a clockwise direction and light 625′ is that light energy traversing fiber 320 in a counterclockwise direction.

Within filter 610, light 625 is applied to a partially transmissive, non-reflective assembly, such as mirror 620. Mirror 620 is operable to select at least one wavelength, λ₁, 635, to pass through and continue in fiber 320, while causing each other wavelength, i.e., ≠λ₁, 630, to be reflected away and removed from fiber 320. Mirror 620 is similarly operable on light 625′ traversing fiber 320 in a counterclockwise direction so that at least one selected wavelength, 635′ remains within fiber 320 and all other wavelengths, 630′ are reflected and removed from fiber 320

As would be appreciated, at least one wavelength may be selected based on the angle of incidence of light 625, 625′ with regard to mirror 620. In a preferred embodiment, an angle is selected such that a desired single wavelength or narrow band of wavelengths is maintained in fiber 320 and all others wavelengths are removed from the fiber.

FIG. 6b illustrates another embodiment of the present invention using a variable coupler 410 and non-reflective filter 610. Phase controllers 240 contribute a zero phase and, hence, need not depicted. In this embodiment, the field reflection and field transmission ratios may be determined as:

$$\begin{matrix}\frac{{E}_{r}}{{E}_{i}} = - j2cos ( κ L ) sin ( κ L ) {t}_{f} ; and & ( 16 ) \\ \frac{{E}_{t}}{{E}_{i}} = ( {cos}^{2} κ L - {sin}^{2} κ L ) {t}_{f} & ( 17 )\end{matrix}$$

where K is the coefficient of coupling;

L is the length of coupling; and

t_{f} is the filter field transmission coefficient at filter center frequency.

The signal intensities may then be determined as:

$${\vert \frac{{E}_{r}}{{E}_{i}} \vert}^{2} = {t}_{f}^{2} {sin}^{2} ( 2 κ L ) and {\vert \frac{{E}_{t}}{{E}_{i}} \vert}^{2} = {t}_{f}^{2} {cos}^{2} ( 2 κ L ) \qquad ( 18 )$$

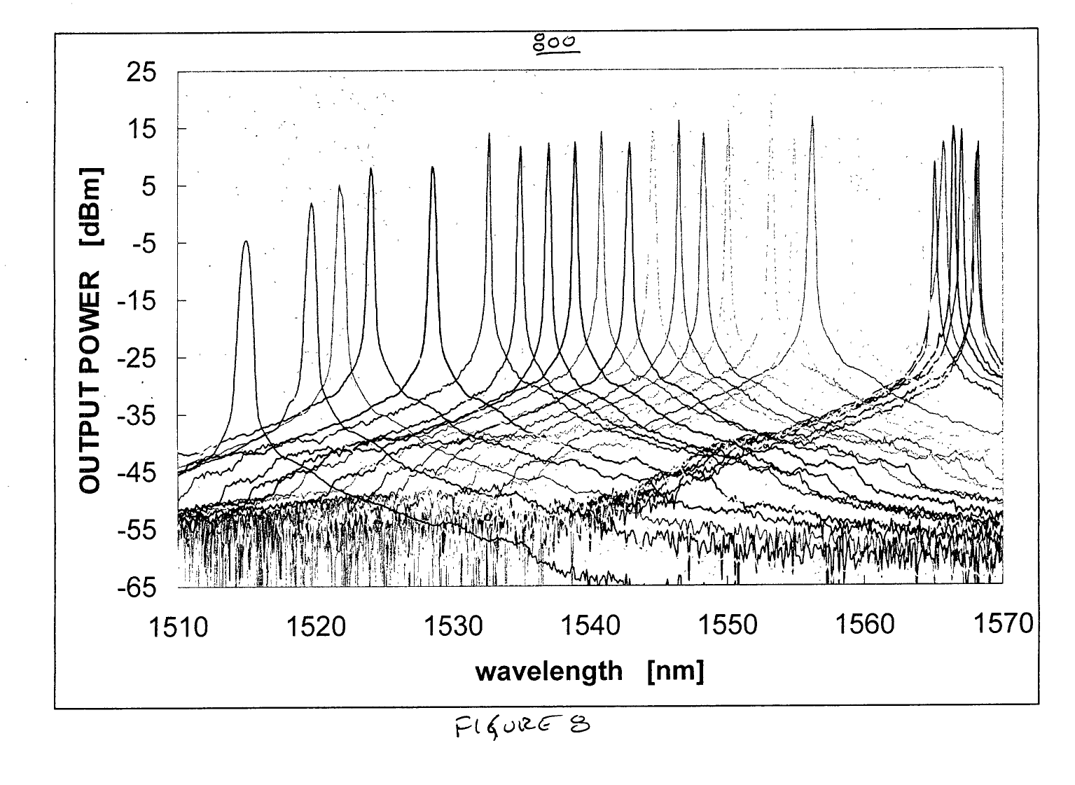

FIG. 7 illustrates a graph 700 of experimental results demonstrating a tunable laser in accordance with the embodiment shown in FIG. 6b. In this graph, wavelengths in the range of 1510-1570 nanometers (nm) may be uniquely achieved by altering a displacement value of a mechanically tunable tilt filter that alters the angle of mirror 620 with regard to the incident angle of light 625, 625′.

FIG. 8 illustrates a composite graph of output power for each lasing wavelength achieved using a tunable laser configuration shown in FIG. 6b. As would be appreciated, output power is relatively constant in the range of 1530-1570 nm.

While there has been shown, described, and pointed out, fundamental novel features of the present invention, it will be understood that various omissions and substitutions and changes in the apparatus described, in the form and details of the devices disclosed, and in their operation, may be made by those skilled in the art without departing from the spirit of the present. For example, the present invention has been described with regard to discrete optical components, however, it would be understood that the present invention may be operated using Integrated Photonic devices and hence are considered within the scope of the invention. Hence, other forms of optical waveguides would be understood to be used in place of optical fibers for transporting light from one device to another. It is further expressly intended that all combinations of those elements which perform substantially the same function in substantially the same way to achieve the same results are within the scope of the invention. Substitutions of elements from one described embodiment to another are also fully intended and contemplated.

What is claimed is:

1. A wavelength-selective variable mirror, comprising:
a coupler having at least one input port and two output ports operable to distribute an associated known level of light applied to a first input port to each of said output ports;
an optical channel extending from each of the said output ports; and
at least one wavelength-selective device coupled to at least one of said optical channels operable to return a predetermined wavelength of said light back to said optical channels.

2. The variable mirror as recited in claim 1, wherein said at least one wavelength selective device is further operable to transmit in both directions said light from one of said optical channels to the other one of said extended optical channels forming an optical loop.

3. The variable mirror as recited in claim 2 further comprising:
at least one phase controlling element inserted in at least one of said optical channels between a corresponding coupler output port and said at least one wavelength-selective device.

4. The variable mirror as recited in claim 1 further comprising:
at least one phase controlling element inserted in at least one of said channels between a corresponding coupler output port and said at least one wavelength-selective device.

5. The variable mirror as recited in claim 4, wherein each of said at least one wavelength selective devices reflect substantially identical light spectrum back to a corresponding one of said optical channels.

6. The variable mirror as recited in claim 4, where said wavelength selective device reflects substantially different light spectrum back to a corresponding one of said optical channels.

7. The variable mirror as recited in claim 6, where said reflected light spectrum is identical for at least one wavelength within a spectral range.

8. The variable mirror as recited in claim 1 wherein said coupler, optical channel and said wavelength-selective device are monolithically integrated.

9. The variable mirror as recited in claim 3, wherein said at least one phase controlling element is monolithically integrated with at least one of said coupler, said optical channel, said wavelength-selective device.

10. The variable mirror as recited in claim 1, wherein said coupler is selected form the group comprising: Mach-Zehnder interferometer, fixed optical couplers, variable optical couplers, overcoupled optical coupler, multi-mode interference coupler, optical taps.

11. The variable mirror as recited in claim 3, wherein said at least one phase controlling element introduces a zero phase.

12. The variable mirror as recited in claim 3, wherein said at least one phase controlling elements introduces a known amount of phase.

13. The variable mirror as recited in claim 1, wherein said at least one wavelength-selective device is an optical filter.

14. The variable mirror as recited in claim 1 wherein wavelength-selective device selected from the group comprising: Fabry-Perot filter, Fiber Bragg Grating, tilt filter, ring resonator.

15. The variable mirror as recited in claim 1, wherein a phase of said coupler is established electrically.

16. The variable mirror as recited in claim 1, wherein a phase of said coupler is established mechanically.

17. A frequency selective tunable laser comprising:
a gain material operable to generate light, having a highly reflective mirror at a first end, in optical communication at a second end to a variable mirror comprising:
a coupler unit having two input ports and two output ports;
an optical channel coupled to each of said coupler output ports; and
a filter coupled to said optical channels operable to return a predetermined wavelength of said light back to said gain material through a first one of said input ports and return lasing light at a second one of said coupler input ports.

18. The tunable laser as recited in claim 17, wherein said filter is operable to transmit light from one of said optical channels to the other one of said extended optical channels in both directions forming an optical loop.

19. The tunable laser as recited in claim 17 further comprising:
at least one phase controlling element inserted between at least one of said output ports of said coupler and said filter.

20. The tunable laser as recited in claim 17 where said highly reflective mirror is formed as a cleaved facet of said gain material.

21. The tunable laser as recited in claim 17, wherein an anti-reflective coating is applied to said second end.

22. The tunable laser as recited in claim 17, wherein said gain material includes a guiding channel tilted with respect to said second end to reduce reflection at said second end.

23. The tunable laser as recited in claim 17, wherein said coupler is selected from the group comprising: Mach-Zehnder interferometer, fixed optical coupler, variable optical coupler, overcoupled optical coupler, multi-mode interference coupler, optical tap.

24. The tunable laser as recited in claim 19, wherein said at least one phase controlling element introduces a zero phase

25. The tunable laser as recited in claim 19, wherein said at least one phase controlling element introduces a known amount of phase.

26. The tunable laser as recited in claim 17, wherein said filter is selected from the group comprising: Fabry-Perot filter, Fiber Bragg Grating, tilt filter, ring resonator.

27. The tunable laser as recited in claim 17 wherein a phase of said coupler is established electrically.

28. The tunable laser as recited in claim 17 wherein a phase of said coupler is established mechanically.

29. The tunable laser as recited in claim 17, wherein a time varying signal is applied to said coupler.

30. The tunable laser as recited in claim 17, wherein a time varying signal is applied to said filter.

31. The tunable laser as recited in claim 29, wherein said time varying signal is periodical.

32. The tunable laser as recited in claim 31, wherein said periodic time varying signal operates to generate a multi mode-locked operation.

33. The tunable laser as recited in claim 32, wherein said filter has a periodical spectra that determines a separation between said multi modes.

34. The tunable laser as recited in claim 30, wherein said time varying signal is periodical.

35. The tunable laser as recited in claim 30, wherein said periodic time vary signal operates to generate a multi-mode-locked operation.

36. The tunable laser as recited in claim 35, wherein said filter has a periodical spectra that determines a frequency between said multi modes.

37. The tunable laser as recited in claim 17, wherein said optical components are fabricated from optical materials selected from the group comprising: Lithium Niobate (LiNbO₃), silica on silicon (SOS), AlGaAs, InGaAsP/InP.

38. The tunable laser as recited in claim 17, wherein said coupler is fabricated from a semiconductor compound.

39. The tunable laser as recited in claim 17, wherein said gain material, said coupler, said filter are monolithically integrated.

40. The tunable laser as recited in claim 19, wherein said at least one phase controlling element is monolithically integrated with at least one of said coupler, said optical channels, said filter.
